(19) United States
(12) Patent Application Publication
(10) Pub. No.: US 2011/0139006 A1
(43) Pub. Date: Jun. 16, 2011

(54) Vehicle Air Filter Fragrancing Device

(76) Inventor: Robert J. Mueller, JR., Brown Deer, WI (US)

(21) Appl. No.: 12/635,393

(22) Filed: Dec. 10, 2009

(51) Int. Cl. B01D 51/10; B01D 50/00

(52) U.S. Cl. 95/285; 96/222

(57) ABSTRACT

A fragrancing device for a vehicle air filter is provided that includes a body formed of a material and incorporating a fragrance in the material forming the body, the body having a configuration adapted to align with a structure of a filter material in a vehicle air filter, and at least one attachment clip releasably engaged with the body the filter material of the filter to attach the body to the filter material.

### FIELD OF THE INVENTION

The present invention vehicle cabin air filters, and more particularly to a device attachable to a vehicle air filter to scent air passing through the filter and into the automobile cabin.

### BACKGROUND OF THE INVENTION

In most vehicles, the air circulation system for a driver/passenger cabin of a vehicle includes a filter for removing a significant portion of particulate matter from the incoming air prior to passing the air into the passenger cabin, or to clean air already present in the cabin and being recirculated through the air filtration system to the cabin. The filters are constructed with a filter media held within a frame that can be releasably secured to the vehicle in the required location to filter the incoming air flow. The filter construction can take various forms depending upon the particular construction of the vehicle, and are disposable, such that the filter can periodically be replaced due to the build-up of particulate matter on the filtering portion of the filter.

While the air filter is effective in removing particulate matter from an incoming cabin air flow, the filter cannot effectively remove any odors or smells from the air flow. As a result, in order to combat unpleasant odors carried by incoming air, additional fragrancing devices are placed within the passenger cabin to attempt to mask these odors. These devices are adapted to be positioned about the passenger cabin in a variety of locations, such as hanging from a string positioned around a rear view mirror support, or adhesively mounted to the dashboard of the vehicle.

However, none of the devices utilized for this purpose are effective in treating the odor prior to the odor being carried into the driver/passenger cabin or compartment. Therefore, it is desirable to develop a fragrancing device that can control, treat and/or mask an odor in an incoming air flow prior to the odor reaching the passenger compartment of a vehicle.

### SUMMARY OF THE INVENTION

According to a one aspect of the present invention, a fragrancing device is provided that can be releasably secured to an air filter for the cabin of a vehicle, such as an automobile, to treat the incoming air flow that passes through the air filter and into the driver/passenger cabin or compartment of the vehicle, or to remove odors from air being recirculated within the cabin. The fragrancing device can be formed of a suitable material that contains an amount of a fragrance, deodorizing or other similar material therein. The device can be secured directly to the filter to enable the fragrance contained within the device to be dispensed into the air flowing through the filter into the cabin of the vehicle.

According to another aspect of the present invention, the device can optionally be formed of a material similar to that of the filter such that air flow can pass directly through the device to have the fragrance dispensed into the air flow.

According to still another aspect of the present invention, the device can be formed to have a size that is less than that of the air filter such that the device does not present any significant obstructions to the air flow passing through the filter.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present invention.

In the drawings:

FIG. 1 is an isometric view of an embodiment of a fragrancing device constructed according to the present invention secured to a vehicle air filter;

FIG. 2 is a front isometric view of the device of FIG. 1;

FIG. 3 is a cross-sectional view along line 3-3 of FIG. 2;

FIG. 4 is a front isometric view of a second embodiment of the fragrancing device.

### DETAILED DESCRIPTION OF THE INVENTION

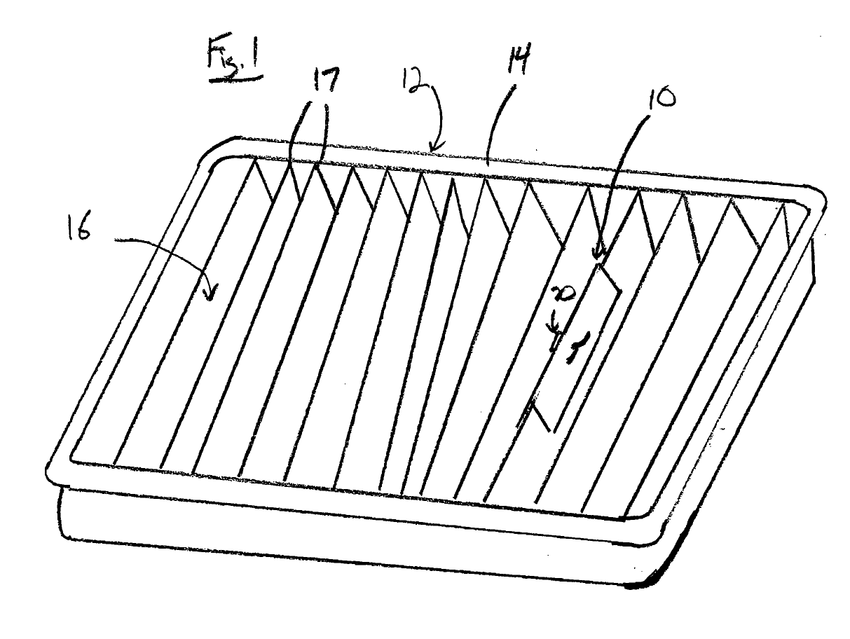

With reference now to the drawing figures in which like reference numerals designate like parts throughout the disclosure, one embodiment of a fragrancing device 10 constructed according to the present invention is shown secured to a vehicle air filter 12 in FIG. 1.

The air filter 12 is a conventional cabin air filter for use in vehicles, such as automobiles, and can have a variety of configurations adapted to be utilized with particular vehicles. However, regardless of the particular configuration, the air filter 12 generally includes a frame 14 that supports a filter material 16 therein. The filter material 16 is any suitable filtering material, such as a natural or synthetic fibrous material formed by chemically or thermally bonding the fibers to one another, including a cellulose-based material, e.g., paper, or fiberglass material, that is air permeable in nature and porous. The filter material 16 is held within the frame 14 that is formed of any suitable material, such as a substantially rigid but lightweight material, including paper-based materials or plastics, among others. The filter material 16 can be secured to the frame in any suitable manner, such as by adhesively attaching or mechanically securing the filter material 16 to the frame 14, including molding the frame 14 directly into connection with the filter material 16 in a manner that prevents the flow of any air between the frame 14 and the filter material 16.

In order to increase the available surface area for filtration purposes, the filter material 16 is preferably formed of a thin sheet of the material that is subsequently shaped, e.g., pleated, to form a surface for the material 16 with a surface area greater than the planar surface area within the frame 14. In the exemplary embodiment of FIG. 1, the filter material 16 is formed with a number of pleats 17 to increase the surface area of the filter material 16 available to trap particulate matter present in the incoming air flow.

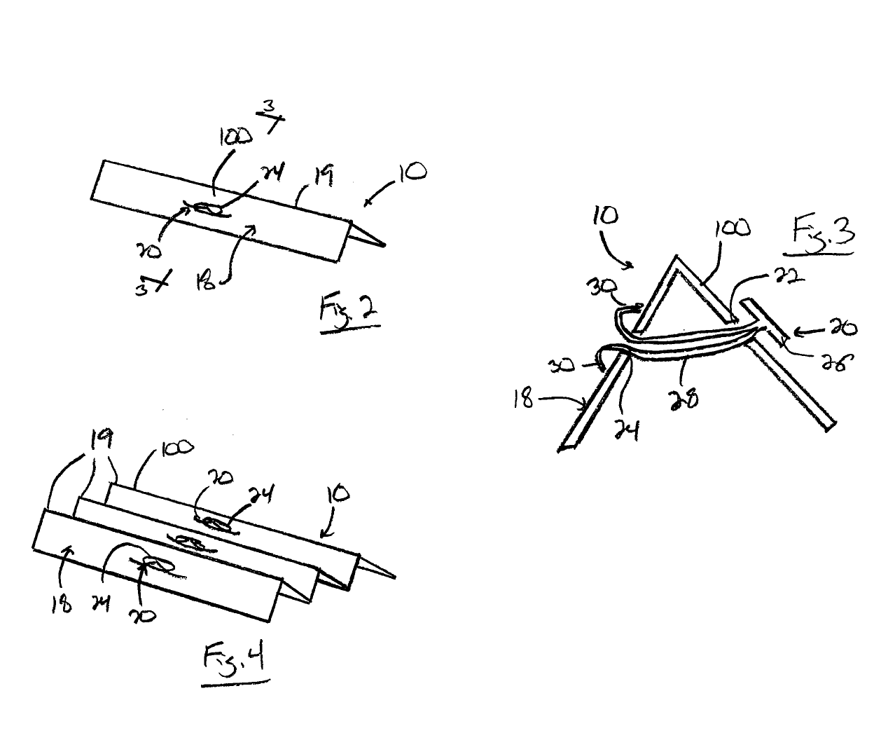

Looking now at FIGS. 1-3, the body 100 of the device 10 can be formed of any suitable material 18, such as a relatively thin sheet of a natural or synthetic fibrous material formed by chemically or thermally bonding the fibers to one another, including a cellulose-based material, e.g., paper, or fiberglass material. The device 10 can additionally be formed from a suitable material 18 that is air permeable in nature and porous, similar to the filter material 16. Regardless of the particular material 18 utilized to form the device 10, the device 10 is also formed to include a fragrance. The fragrance can have any desired scent, and can be applied to the material 18 forming the body 100 in any conventional manner, such as by applying the fragrance to the material 18 as a coating, incorporating the fragrance within any adhesives utilized to hold the material 18 together in the form of the device 10, or otherwise incorporating the fragrance on or within the material 18 forming the body 100 of the device 10.

The body 100 of the device 10 is formed to be complementary in shape to the configuration of the filter material 16. In this manner, the device 10 does not obstruct the positioning of the filter 12 within the specified location inside of the vehicle. Additionally, the size of the body 100 of the device 10 is optionally selected to be less than the size of the filter material 16, such that the device 10 does not significantly obstruct the air flow through the filter 12 when attached to the filter material 16.

In one embodiment, the body 100 of the device 10 is formed with the material 18 having a V-shaped pleated configuration that easily mates with the corresponding pleats 17 in the filter material 16, as shown in FIG. 1. The device 10 having this configuration may include sufficient material to form a number of pleats 19 (FIG. 4), if desired. The device 10 snugly fits against the pleats 17 of the filter material 16, such that the profile of the device 10 does not hinder the insertion or removal of the filter 12 from the vehicle. Optionally, the device 10 does not extend beyond the profile of the frame 14 to achieve this purpose.

To secure the device 10 to the filter material 16 where desired, an attachment clip 20 is engaged between the device 10 and the filter material 16. The attachment clip 20 can have any suitable configuration that is capable of securing the device 10 to the filter material 16 and/or the frame 14 in a nested configuration with the filter material 16. Additionally, the clip 20 can be formed of any suitable material, with a metal or hard plastic being preferred.

In one embodiment, the clip 20 is inserted through a first opening 22 in the device 10, subsequently through one of the pleats 17 in the filter material 16, and through a second opening 24 in the device 10 that is disposed on the opposite side of the device 10 in alignment with the first opening 22. The clip 20 has a head 26 at one end that is larger than the first opening 22 to prevent the clip 20 from passing entirely through the first opening 20. Extending from the head 26 is a shaft 28 having a relatively pointed tip 30 that easily penetrates and passes through the filter material 16. The shaft 28 also has a relatively small cross-section in order to minimize the obstruction to the air flow passing through the filter 12. Additionally, the shaft 28 has a length sufficient to enable the tip 30 to pass entirely through the filter material 16 and out the second opening 24 without overly compressing the pleat 17 in the filter material 16 over which the device 10 is placed to avoid compromising the filtering capacity of the filter material 16 immediately adjacent the device 10.

Once the tip 30 exits the device 10 through the second opening 24, the tip 30 can be engaged with a suitable locking cap (not shown), or can simply be bent to one side of the second opening 24 to prevent the clip 20 from sliding back through the device 10 and filter material 16. The clip 20 is only releasably secured to the device 10 such that the clip 20 can easily be removed from the device 10.

The removal of the clip 20 is desirable in certain embodiments as it enables the device 10 to be completely removed from the filter material 16. This is desirable when the fragrance held within the material 18 forming the device 10 is depleted and the device 10 is to be replaced with a new device 10. To replace the device 10, the clip 20 can be removed from the device 10 and the filter material 16, and the device 10 taken off of the filter material 16. A new device 10 with the same or a different fragrance incorporated therein can then be positioned on the filter material 16 in the same location as the prior device 10 or in a different location, and subsequently attached to the filter material 16 using the clip 20.

In alternative embodiments, the device 10 can be fixed to the filter material 16 in a non-removable manner, such that the device 10 is simply disposed of with the air filter 12 when the filter 12 is replaced. Additionally, depending upon the size of the body 100 of the device 10, i.e., when multiple pleats 19 are formed in the body 100, multiple clips 20 can be used to secure the device 10 to the filter material 16 of the filter 12. Further, so long as the clip 20 can penetrate through the structure of the body 100, the first opening 22 and second opening 24 can be omitted from the device 10.

Various other embodiments of the present invention are contemplated as being within the scope of the filed claims particularly pointing out and distinctly claiming the subject matter regarded as the invention.

1. A fragrancing device comprising:
a) a body formed of a material and incorporating a fragrance in the material forming the body, the body having a configuration adapted to align with a structure of a filter material in a vehicle air filter; and
b) at least one attachment clip engaged with the body and adapted to be engaged with the filter material of the filter to attach the body to the filter material.

2. The device of claim 1 wherein the body has a V-shaped configuration adapted to align with a pleated filter material.

3. The device of claim 1 wherein the body is formed with a pair of opposed and aligned openings adapted to be positioned on opposite sides of the filter material to receive the attachment clip therethrough.

4. The device of claim 1 wherein the clip is releasably attached to the body.

5. The device of claim 1 wherein the body is formed of an air permeable material.

6. The device of claim 1 wherein the body is formed of a material selected from the group consisting of: a natural fiber material and a synthetic fiber material.

7. A method of providing a scent to air flowing through a vehicle air filter, the method comprising the steps of:
a) providing a fragrancing device including a body formed of a material and incorporating a fragrance in the material forming the body, the body having a configuration adapted to align with a structure of a filter material in a vehicle air filter and at least one attachment clip engaged with the body and adapted to be engaged with the filter material of the filter to attach the body to the filter material;
b) securing the body to a complementary shaped filter material forming the vehicle air filter; and
c) placing the vehicle air filter and the fragrancing device in a vehicle.

8. The method of claim 7 further comprising the steps of:
a) removing the air filter and fragrancing device from the vehicle;
b) removing the device from the air filter;
c) securing a new fragrancing device to the air filter; and
d) replacing the air filter in the vehicle.

9. The method of claim 7 wherein the step of securing the body to the filter material comprises engaging the attachment clip with the body and filter material.

10. The method of claim 9 wherein the step of engaging the attachment clip to the body and the filter material comprises inserting the attachment clip through opposite sides of the body and the filter material.
